(19) United States
(12) Patent Application Publication
(10) Pub. No.: US 2008/0209401 A1
(43) Pub. Date: Aug. 28, 2008

(54) Techniques for integrating debugging with decompilation

(75) Inventors: Michael C. Fanning, Redmond, WA (US); Steven J. Steiner, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/709,447

(22) Filed: Feb. 22, 2007

(51) Int. Cl. G06F 9/44

(52) U.S. Cl. 717/124

(57) ABSTRACT

Various technologies and techniques are disclosed for integrating debugging with decompilation. A debugger integrated with a decompiler is provided. The system determines a need to debug at least a portion of an application for which necessary debug information is not available. A decompile process is performed to decompile a binary into a decompiled source code in a particular language. A symbol file is generated that maps code sequence execution points to the decompiled source code. The decompiled source code and the symbol file are provided to the debugger. The debugging then continues using the decompiled source code. The user is able to debug applications when source code and symbol files are not available, and/or when the user prefers to debug in a different language than the language of the available source code.

### BACKGROUND

In the modern software development industry, software developers will first write program logic, called source code, and then compile and test their programming logic. In the event that the developer finds an issue, that developer will begin a process of iterating through the programming logic one source code instruction at a time using a process called source debugging. Source debugging functionality is typically part of modem software development programs. The ability to debug an application in this fashion typically requires that three requirements be met: first, that the original source code is available to use; second, that the application can be created in a functional, executable binary; and third, that a symbol file is available which contains the information necessary to map the source code to the binary.

It may become necessary to debug binaries for an installed application, for binaries from other parties, and/or for custom applications for which source code is no longer available. Often times, these binaries are missing the source code and/or a symbol file, both of which are required for source debugging. If there is an error either directly in that binary or resulting from its use with the overall application, it becomes very difficult for the developer to diagnose or fix the issue. What generally happens when an error of this nature is encountered is that the development environment pauses debugging operations and informs that user that there is no debugging information available and offers the user one or more options. Common options include allowing the user to continue running the application as though the error hadn't been encountered or to discontinue debugging all together. Some development environments allow the user to view the environment-specific machine language, which is difficult to understand and analyze. None of these scenarios provides any benefit to the application developer when they are attempting to identify, diagnose, and correct errors within their application.

### SUMMARY

Various technologies and techniques are disclosed for integrating debugging with decompilation. A debugger integrated with a decompiler is provided. The system determines a need to debug at least a portion of an application for which necessary debug information is not available. Examples of necessary debug information include source code and/or symbol files. A decompile process is performed to decompile a binary into a decompiled source code in a particular language. In one implementation, the particular language can be a higher level language or another language. A symbol file is generated that maps code sequence execution points to the decompiled source code. The decompiled source code and the symbol file are provided to the debugger. The debugging then continues using the decompiled source code. In one implementation, the user is able to use the integrated debugger/decompiler to debug applications when source code and symbol files are not available. In another implementation, the user is able use the integrated debugger/decompiler to debug in a different language than the language of the available source code.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of an integrated debugger/decompiler application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the more detailed stages involved in integrating a debugger with a decompiler.

FIG. 5 is a process flow diagram for one implementation of the system of FIG. 1 illustrating the stages involved in allowing debugging to continue when a point is reached where required source code and symbol files are not available.

FIG. 6 is a process flow diagram for one implementation of the system of FIG. 1 illustrating the stages involved in allowing portions of source code to be identified as eligible for decompilation.

FIG. 7 is a process flow diagram for one implementation of the system of FIG. 1 that illustrates the stages involved in allowing a user to debug an application in a different language than the one source code is available for.

FIG. 8 is a logical diagram for one implementation of the integrated debugger/decompiler application of FIG. 2.

FIG. 9 is a logical diagram illustrating the high level features implemented by an integrated debugger/decompiler.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as a software development application that enables source debugging, but the system also serves other purposes in addition to these. In one implementation, one or more of the techniques described herein can be implemented as features within an software development program such as MICROSOFT® VISUAL STUDIOS®, or from any other type of program or service that allows for debugging of software applications.

In one implementation, a debugger is integrated with a decompiler to allow source debugging to continue when source code and symbol files are not available for a binary. The decompilation process generates the needed source code and/or symbol files and allows the debugging to continue. The system can also be used for debugging applications for which source code is available, but where the user prefers to debug in a different programming language. For example, the user may be more comfortable with one language over another language, and the integrated debugger/decompiler allows the user to debug in the language of choice.

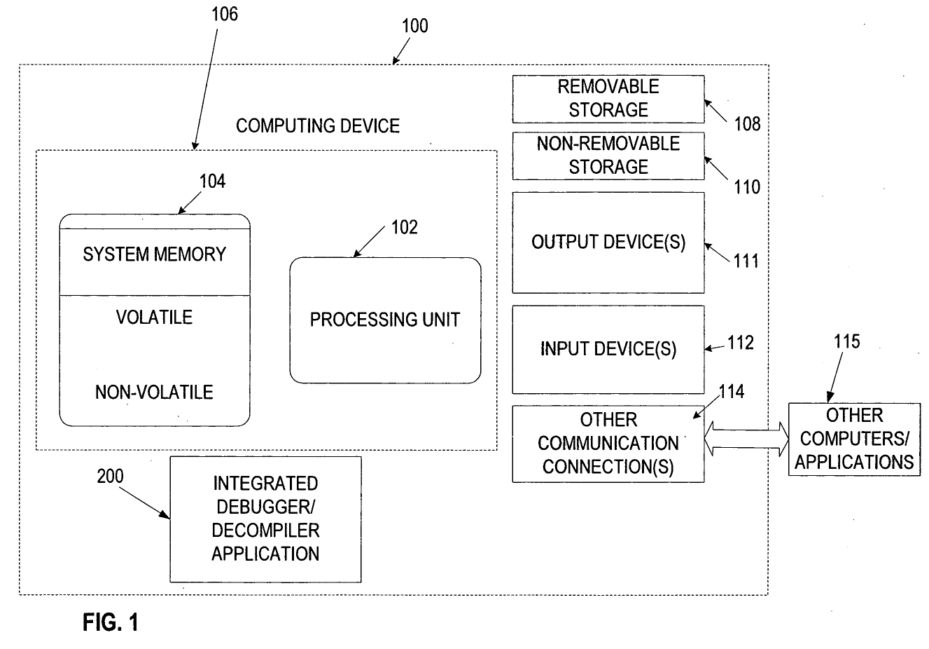

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

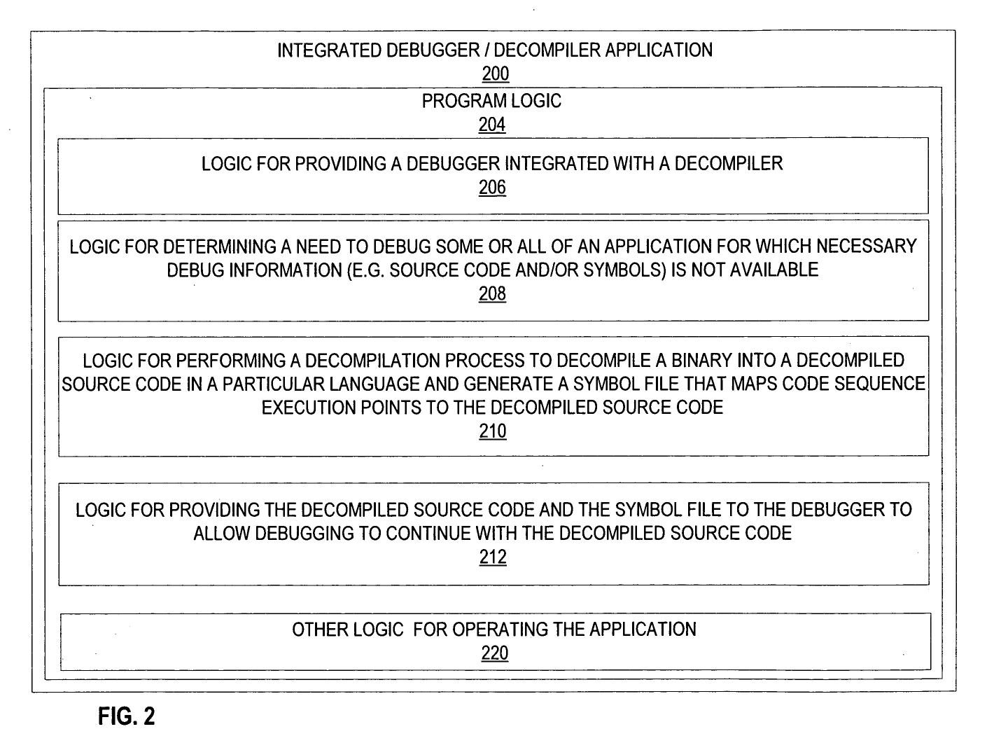

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes integrated debugger/decompiler application 200. integrated debugger/decompiler application 200 will be described in further detail in FIG. 2.

Turning now to FIG. 2 with continued reference to FIG. 1, an integrated debugger/decompiler application 200 operating on computing device 100 is illustrated. integrated debugger/decompiler application 200 is one of the application programs that reside on computing device 100. However, it will be understood that integrated debugger/decompiler application 200 can alternatively or additionally be embodied as computer-executable instructions on one or more computers and/or in different variations than shown on FIG. 1. Alternatively or additionally, one or more parts of integrated debugger/decompiler application 200 can be part of system memory 104, on other computers and/or applications 115, or other such variations as would occur to one in the computer software art.

Integrated debugger/decompiler application 200 includes program logic 204, which is responsible for carrying out some or all of the techniques described herein. Program logic 204 includes logic for providing a debugger integrated with a decompiler 206; logic for determining a need to debug some or all of an application for which necessary debug information (e.g. source code and/or symbols) is not available 208; logic for performing a decompilation process to decompile a binary into a decompiled source code in a particular language and generate a symbol file that maps code sequence execution points to the decompiled source code 210; logic for providing the decompiled source code and the symbol file to the debugger to allow debugging to continue with the decompiled source code 212; and other logic for operating the application 220. In one implementation, program logic 204 is operable to be called programmatically from another program, such as using a single call to a procedure in program logic 204.

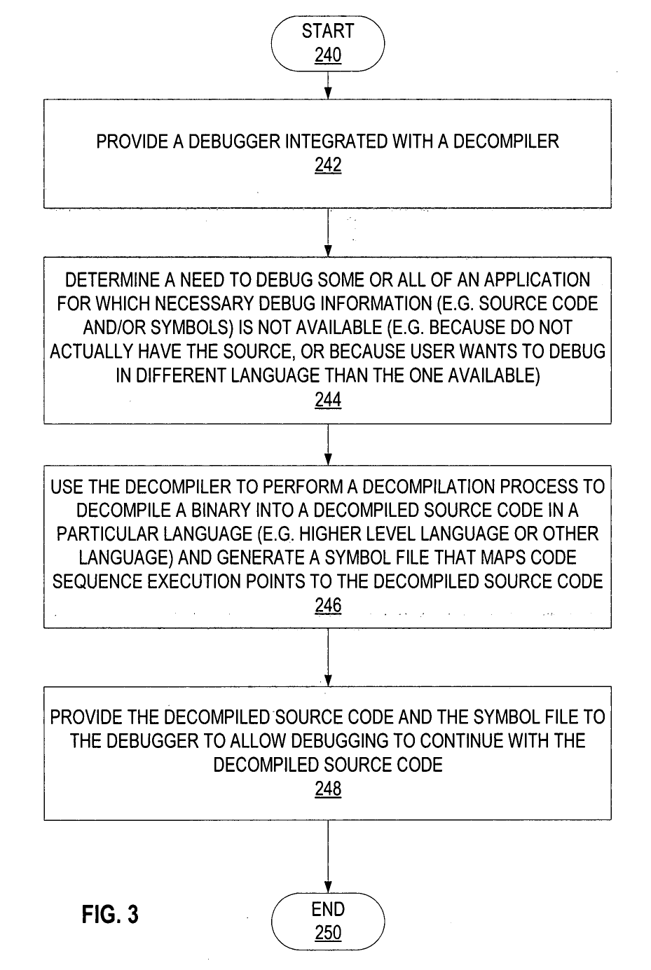

Turning now to FIGS. 3-7 with continued reference to FIGS. 1-2, the stages for implementing one or more implementations of integrated debugger/decompiler application 200 are described in further detail. FIG. 3 is a high level process flow diagram for integrated debugger/decompiler application 200. In one form, the process of FIG. 3 is at least partially implemented in the operating logic of computing device 100. The process begins at start point 240 with providing a debugger integrated with a decompiler (stage 242). The system or the user determines a need to debug some or all of an application for which necessary debug information (e.g. source code and/or symbols) is not available (stage 244). In one implementation, the necessary information is not available because the source code and/or symbols are missing (stage 244). In another implementation, the source code is available, but the user wants to debug in different language than the one available (stage 244). The system uses the decompiler to perform a decompilation process to decompile a binary into a decompiled source code in a particular language (e.g. higher level language or other language) and generates a symbol file that maps code sequence execution points to the decompiled source code (stage 246). The term higher level language as used herein means a higher-level representation of source code that is more readable than machine code. That representation could be pseudo-code, or some other reduction. In the case of other languages (C#, Visual Basic, Java, etc.), the decompiled source may or may not be compatible with the language specifications for the particular language. The decompiled source code and the symbol file are provided to the debugger to allow debugging to continue with the decompiled source code (stage 248). The process ends at end point 250.

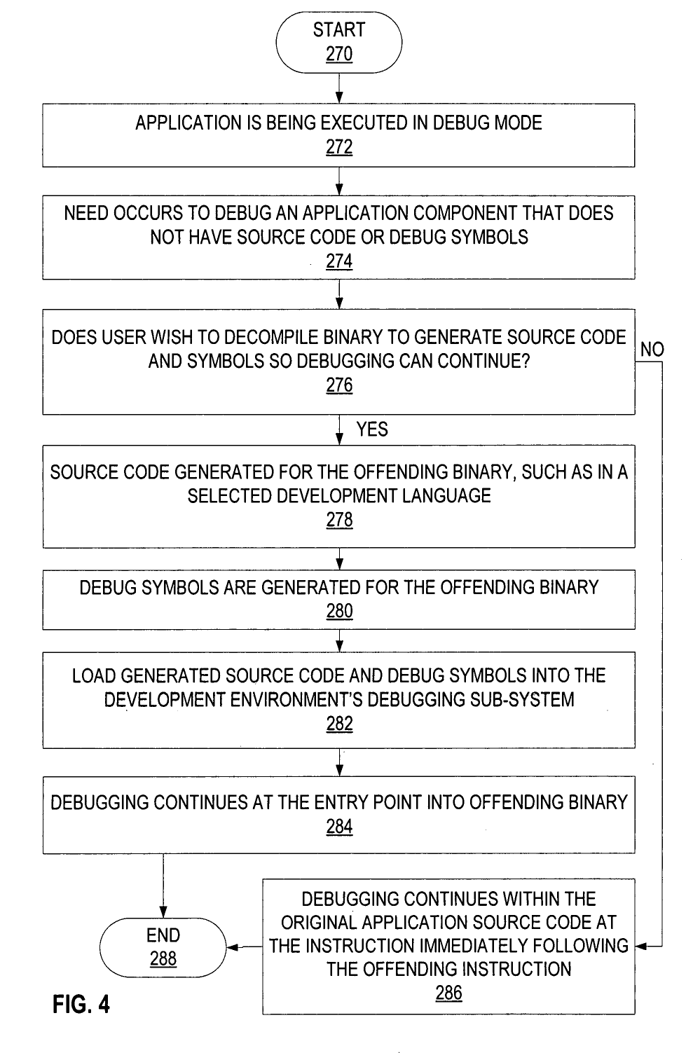

FIG. 4 illustrates one implementation of the more detailed stages involved in integrating a debugger with a decompiler. In one form, the process of FIG. 4 is at least partially implemented in the operating logic of computing device 100. The process begins at start point 270 with the application being executed in debug mode (stage 272). The need occurs to debug an application component that does not have source code for debug symbols (stage 274). If the user indicates, when prompted, a wish to decompile binary to generate source code and symbols so debugging can continue (decision point 276), then source code is generated for the offending binary, such as in a selected development language (stage 278). Debug symbols are then generated for the offending binary (stage 280). The generated source code and debug symbols are loaded into the development environment's debugging sub-system (stage 282). Debugging continues at the entry point into offending binary (stage 284).

If, on the other hand, the user does not indicate a wish to decompile the binary to generate the source and symbols, then debugging continues within the original application source code at the instruction immediately following the offending instruction (stage 286). The process ends at end point 288.

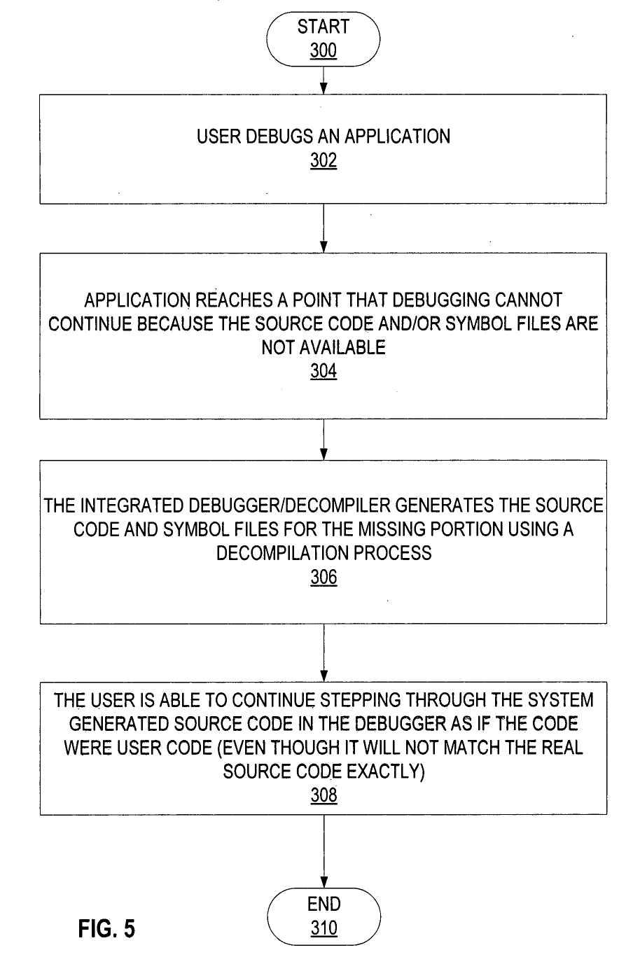

FIG. 5 illustrates one implementation of the stages involved in allowing debugging to continue when a point is reached where required source code and symbol files are not available. In one form, the process of FIG. 5 is at least partially implemented in the operating logic of computing device 100. The process begins at start point 300 with the user debugs an application (stage 302). The application reaches a point that debugging cannot continue because the source code and/or symbol files are not available (stage 304). The integrated debugger/decompiler generates the source code and symbol files for the missing portion using a decompilation process (stage 306). The user is able to continue stepping through the system generated source code in the debugger as if the code were user code (even though it will not match the real source code exactly) (stage 308). The process ends at end point 310.

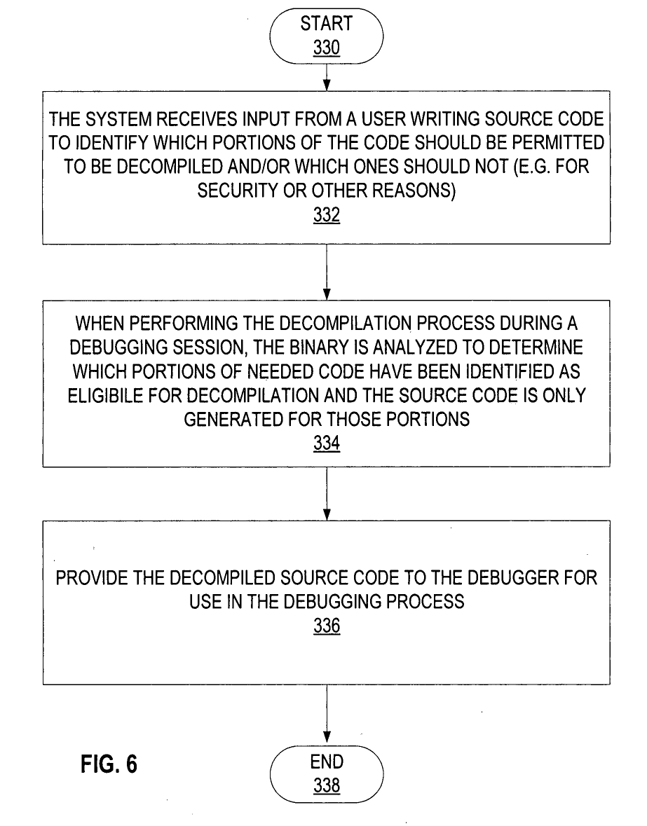

FIG. 6 illustrates one implementation of the stages involved in allowing portions of source code in an application to be identified as eligible for decompilation. In one form, the process of FIG. 6 is at least partially implemented in the operating logic of computing device 100. The procedure begins at start point 330 with the system receiving input from a user writing source code to identify which portions of the code should be permitted to be decompiled and/or which ones should not (e.g. for security or other reasons) (stage 332). When performing the decompilation process during a debugging session, the binary is analyzed to determine which portions of needed code have been identified as eligible for decompilation and the source code is only generated for those portions (stage 334). The decompiled source code is provided to the debugger for use in the debugging process (stage 336). The process ends at end point 338.

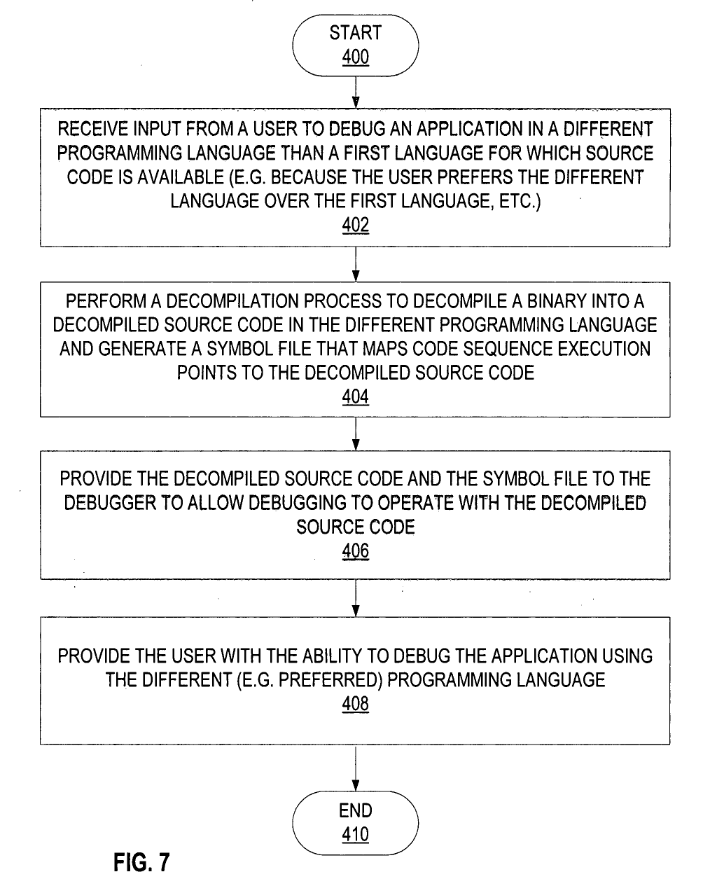

FIG. 7 illustrates one implementation of the stages involved in allowing a user to debug an application in a different language than the one source code is available for. In one form, the process of FIG. 7 is at least partially implemented in the operating logic of computing device 100. The process begins at start point 400 with receiving input from a user to debug an application in a different programming language than a first language for which source code is available (e.g. because the user prefers the different language over the first language, etc.) (stage 402). A decompilation process is performed to decompile a binary into a decompiled source code in the different programming language and generate a symbol file that maps code sequence execution points to the decompiled source code (stage 404). The decompiled source code and the symbol file are provided to the debugger to allow debugging to operate with the decompiled source code (stage 406). The user is provided with the ability to debug the application using the different (e.g. preferred) programming language (stage 408). The process ends at end point 410.

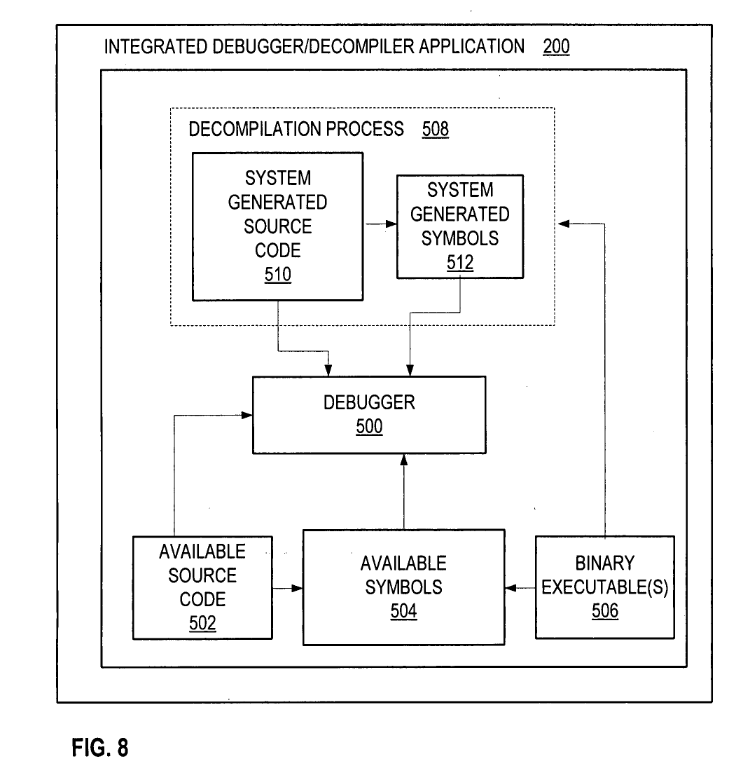

FIG. 8 is a logical diagram for one implementation of the integrated debugger/decompiler application of FIG. 2. Integrated debugger/decompiler application 200 includes a debugger 500 that integrates with a decompilation process 508 when desired. The available source code 502 and available symbols 504 are used by the debugger to debug an application for which source code is available. The symbols are generated from the binary executable(s) 506. The decompilation process 508 is used whenever the source code and symbols are not available, and/or because the user has chosen to debug in a different language. The system generated source code 510 and system generated symbols 512 are then generated using the decompilation process 508 and provided to the debugger 500 so the application can be debugged using the system generated information.

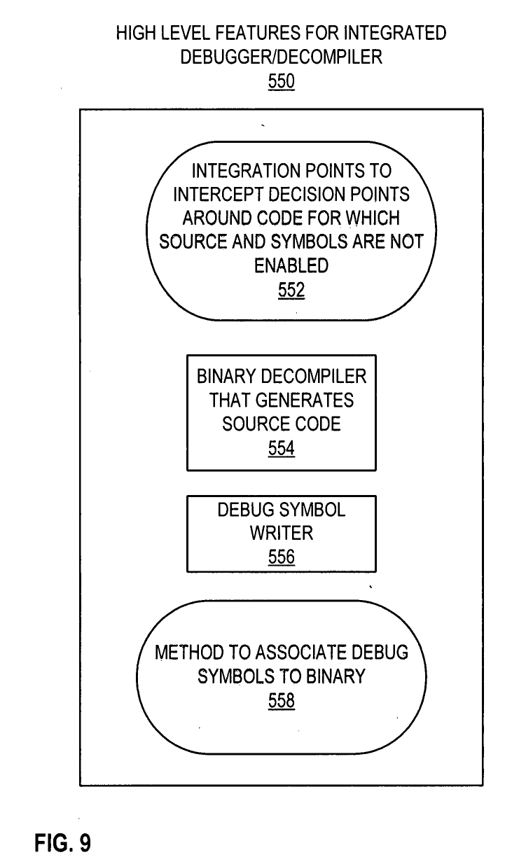

FIG. 9 is a logical diagram illustrating the high level features 550 implemented by an integrated debugger/decompiler of one implementation. The integrated debugger/decompiler 200 includes integration points to intercept decision points around code for which source and symbols are not enabled 552. The integrated debugger/decompiler 200 also includes a binary decompiler 554 that generates the source code, and a debug symbol writer 556 generates the symbol files that map code execution sequence points to the generated source code. Furthermore, a method for associating the debug symbols to the binary 558 is also provided with the integrated debugger/decompiler. In alternate implementations, some, all, and/or additional components can be provided with integrated debugger/decompiler to provide the desired functionality.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A computer-readable medium having computer-executable instructions for causing a computer to perform steps comprising:
provide a debugger integrated with a decompiler;
determine a need to debug at least a portion of an application for which necessary debug information is not available;
perform a decompile process to decompile a binary into a decompiled source code in a particular language;
generate a symbol file that maps code sequence execution points to the decompiled source code; and
provide the decompiled source code and the symbol file to the debugger.

2. The computer-readable medium of claim 1, wherein the necessary debug information that is not available includes source code.

3. The computer-readable medium of claim 1, wherein the necessary debug information that is not available includes a symbol file.

4. The computer-readable medium of claim 1, wherein the debugger is operable to use the decompiled source code and the symbol file to allow debugging to continue.

5. A method for providing an integrated debugger and decompiler application comprising the steps of:
determining a need to debug an application component that does not have required source code and symbols;
decompiling a binary into a particular source code;
generating symbols for the binary;
loading the particular source code and symbols into a debugger; and
allowing the debugging to continue using the particular source code and symbols.

6. The method of claim 5, wherein the user is prompted to specify whether or not to decompile the binary into the particular source code.

7. The method of claim 6, wherein the decompilation only continues if the user specifies a wish to continue with the decompilation.

8. The method of claim 5, wherein the debugging continues at an entry point into the binary.

9. The method of claim 5, wherein the particular source code is written in a selected development language.

10. The method of claim 5, wherein the particular source code is chosen by a user as a preferred debugging language.

11. The method of claim 10, wherein original source code is available in a first language.

12. The method of claim 5, wherein a user is able to step through the particular source code in the debugger as if the particular source code were user code.

13. The method of claim 5, wherein the particular source code does not match an original source code exactly.

14. The method of claim 5, wherein the decompiling the binary is only performed for portions of the binary that have been identified as eligible for decompilation.

15. The method of claim 5, wherein an original source code for the binary indicates which portions of the original source code should be eligible for decompilation.

16. The method of claim 5, wherein the particular source code is written in a higher level language than an original source code.

17. A computer-readable medium having computer-executable instructions for causing a computer to perform the steps recited in claim 5.

18. A method for debugging in a different language than a language of available source code comprising the steps of:
receiving input from a user to debug an application in a different programming language than a first language for which original source code is available;
decompiling a binary into a decompiled source code in the different programming language;
generating a symbol file that maps code sequence execution points to the decompiled source code; and
providing the decompiled source code and the symbol file to a debugger to allow debugging to operate with the decompiled source code.

19. The method of claim 18, further comprising:
providing the user with an ability to debug the application using the different programming language than the first language for which original source code is available.

20. A computer-readable medium having computer-executable instructions for causing a computer to perform the steps recited in claim 18.
